(19) United States
(12) Patent Application Publication
(10) Pub. No.: US 2026/0031262 A1
(43) Pub. Date: Jan. 29, 2026

(54) DEVICE FOR GENERATION OF EXTERNAL MAGNETIC FIELD IN PRODUCTION COLUMNS

(71) Applicants: Petróleo Brasileiro S.A. - Petrobras, Rio de Janeiro (BR); Centro Brasileiro de Pesquisas Fisicas - CBPF, Rio de Janeiro (BR)

(72) Inventors: Rubem Luis SOMMER, Rio de Janeiro (BR); Alexandre Zacarias IGNACIO PEREIRA, Rio de Janeiro (BR); Helga Elisabeth PINHEIRO SCHLUTER, Rio de Janeiro (BR); Fernando SALATIEL DE OLIVEIRA, Santos (BR); Bruno GOMES DA SILVA, Rio de Janeiro (BR); Hugo Francisco LISBOA SANTOS, Rio de Janeiro (BR); Alexandre MELLO DE PAULA SILVA, Rio de Janeiro (BR); Andre SANTOS DORIA, Rio de Janeiro (BR); Joao Vicente MARTINS DE MAGALHAES, Rio de Janeiro (BR); Andre LEIBSOHN MARTINS, Rio de Janeiro (BR); Bruno BARBOSA CASTRO, Rio de Janeiro (BR); Elvis Oswaldo LÓPEZ MEZA, Rio de Janeiro (BR); João Paulo SINNECKER, Rio de Janeiro (BR)

(73) Assignees: Petróleo Brasileiro S.A. - Petrobras, Rio de Janeiro (BR); Centro Brasileiro de Pesquisas Fisicas - CBPF, Rio de Janeiro (BR)

(21) Appl. No.: 19/274,138

(22) Filed: Jul. 18, 2025

(30) Foreign Application Priority Data
Jul. 29, 2024 (BR) 20 2024 015531 4

(51) Int. Cl. H01F 7/02

(52) U.S. Cl. CPC H01F 7/021

(57) ABSTRACT

The present disclosure relates to a device for generating an external magnetic field in production columns, comprising at least one magnetic arrangement including at least eight magnets arranged to form a cylinder; wherein the at least eight magnets have a trapezoidal shape and a cylindrical internal and external section; wherein at least four magnets of the at least eight magnets have a convergent magnetic field direction in relation to the center of the cylinder formed by the magnetic arrangement; and at least four magnets of the at least eight magnets have a divergent magnetic field direction in relation to the center of the cylinder formed by the magnetic arrangement; wherein each magnetic arrangement is rotated by 22.5° in relation to a previous magnetic arrangement and a subsequent magnetic arrangement along a production column; and at least one magnetically permeable inner tube arranged within the at least one magnetic arrangement.

### CROSS-REFERENCE TO RELATED APPLICATION

This application claims priority to Brazilian Patent Application No. 20 2024 015531 4, filed on Jul. 29, 2024, the entire contents of which is incorporated herein by reference.

### FIELD OF THE DISCLOSURE

This Utility Model falls within the technical field of oil and gas and is related to oil production processes and outflow technologies. More particularly, this Utility Model relates to a device for generating an external magnetic field in offshore oil well production columns.

The device of this Utility Model can be installed in any pipe used for transporting fluids, including oil well production columns.

### BACKGROUND OF THE DISCLOSURE

Saline scalings in offshore well pipes cause restrictions on fluid flow and compromise hydrocarbon production over time.

An alternative for remediation and/or mitigation of the problem of saline scales in the production column tubes of offshore wells is the use of column elements containing permanent magnets, called Magnetic SUBs.

In the State of the Art, it is known that the application of a magnetic field in the vicinity of a pipe/duct can affect the formation of the scale crystals type (such as vaterite, calcite, aragonite or other amorphous calcium carbonates), due to the interaction between the magnetic force and the charges of the crystal-forming ions present in the fluid.

Thus, the use of a magnetic anti-scaling device appears to be an interesting alternative to treat the problem of scaling, since this device comprises permanent magnets with suitable magnetic properties, which do not require power supply for operation.

Currently, it is possible to perform optimizations in the magnetic field configurations, regarding the volume of interaction with the fluids, the intensity of the magnetic field, and the spatial distribution of the field along the magnetic anti-scaling device. On the other hand, it is clear that there is no theoretical model or method that is efficient for applying this technology in annular regions between the open well and the production columns.

In this sense, and in order to solve the technical problem described above, this Utility Model provides a device for generating an external magnetic field in production columns. aiming at the remediation and mitigation of inorganic scalings in the external part of production columns (annular region).

It is worth highlighting that the device of this Utility Model meets the various specific criteria based on the magnetohydrodynamic (MHD) model, which is the theoretical model that studies the interactions between conductive fluids (and also gases) (ionic and/or saline fluids) and magnetic fields.

In the state of the art there are devices designated for the remediation and/or mitigation of scales in production columns. However, the disclosed devices were not designed to guarantee the efficiency of scale inhibition in annular regions formed by the open well and the production column, maximizing the magnetic field intensity for action external to the diameter of the magnetic SUB.

Document CN104879742A provides a magnetic-force descaling device used for a boiler and belongs to the technical field of industrial machinery: that is, distinct from the technical field of the device of the present Utility Model, which is used in oil production columns. The device disclosed in CN104879742A bears no similarity to the magnetic sub and does not share technical characteristics with the device of the present Utility Model. Furthermore, the document device is electromagnetic, using solenoids and not permanent magnets.

Document BR 102021019006 A2 describes modular tubular equipment to be installed in high-pressure environments, which allows connection to a production column, preventing or delaying the appearance of inorganic scale at the bottom of the well, through the application of a magnetic field.

Furthermore, document BR 1020220155925 A2 describes a device with zig-zag diametrical magnetic arrangements for installations in magnetic SUBs, aiming at the remediation and mitigation of inorganic and organic scalings in production columns, through the action of a magnetic field internal to the diameter of the SUB.

It is understood that documents BR 102021019006 A2 and BR 1020220155925 A2 present distinct projects for similar applications: that is, the magnetic treatment of oil, water and gas mixtures that flow inside a production column of an offshore well. Despite the similarity of purpose, the optimization of the magnetic arrangement proposed in BR 1020220155925 A2, bringing great gains in relation to BR 102021019006 A2, was considered sufficient to guarantee an inventive act, as it is a project with a totally different magnetic arrangement.

The device of this Utility Model is capable of providing concentration of the magnetic field in the area external to the device, with the aim of treating portions of water, oil and gas mixture that are flowing in the annular region formed by the walls of the well and the production column.

### SUMMARY OF THE DISCLOSURE

In order to reduce and/or mitigate saline scalings in annuli external to production columns, this Utility Model provides a device for generating an external magnetic field in production columns.

The new magnetic arrangement of permanent magnets of the device of the present Model provides a new magnetic field configuration to the magnetic SUBs already used in the State of the Art, increasing the capacity to concentrate the magnetic field in the area external to the device, with the objective of treating portions of water, oil and gas mixture that are flowing in the annular region formed by the walls of the well and the production column.

This effect is achieved by introducing an inner tube into the magnetic arrangement, made of steel permeable to the magnetic field (ferromagnetic steels), directing the magnetic field towards the external portion of the device. Additionally, the present Model includes an optimization of the magnetic moments orientations of the magnets, in order to guarantee the desired magnetic field in the portion external to the device.

The present Utility Model defines a device for generating an external magnetic field in production columns containing at least one magnetic arrangement comprising at least eight magnets arranged to form a cylinder, wherein the at least eight magnets have a trapezoidal shape and a cylindrical internal and external section: wherein at least four magnets of the at least eight magnets have a convergent magnetic field direction in relation to the center of the cylinder formed by the magnetic arrangement; and at least four magnets of the at least eight magnets have a divergent magnetic field direction in relation to the center of the cylinder formed by the magnetic arrangement: wherein each magnetic arrangement is rotated by 22.5° in relation to a previous magnetic arrangement and a subsequent magnetic arrangement, along a production column; and at least one inner tube, arranged inside the at least one magnetic arrangement.

Additionally, at least eight magnets are higher grade neodymium (NdFeB), such as N48SH.

Additionally, between at least eight magnets there is a separation, wherein the separation distance is 4 millimeters from each other, and wherein an Inconel plate is arranged in the separation; and wherein each magnet has a length of 5 centimeters.

At least one magnetic arrangement has an outer diameter of 18.8 centimeters and an inner diameter of 11.4 centimeters.

Specifically, the at least one inner tube is of a ferromagnetic material: more particularly, the at least one inner tube is of SuperDuplex (SD) steel. Additionally, at least one inner tube is 8 millimeters thick.

### BRIEF DESCRIPTION OF THE FIGURES

To obtain a full and complete view of the object of this Utility Model, the attached figures are presented as follows:

FIG. 1 shows at least one magnetic arrangement including at least 8 magnets.

FIG. 2 shows the cross-section of the equipment with the magnetic arrangement and the presence of the inner tube.

FIG. 3 illustrates a graph showing the intensity of the magnetic field in the annulus, where fluids flow, without coating and with a permeable SuperDuplex (SD) steel core.

FIG. 4 is a representation of the radial view of the magnetic field intensity in the annulus, where the fluids flow, without coating and with a permeable SuperDuplex (SD) steel core.

FIG. 5 is a representation of the axial view of the magnetic field intensity along the annulus, where the fluids flow; without coating and with a permeable SuperDuplex (SD) steel core.

### DETAILED DESCRIPTION OF THE DISCLOSURE

This Utility Model defines a device (1) for generating an external magnetic field in production columns, with the purpose of reducing and/or mitigating inorganic and organic scalings in annular regions between the open well and the production column.

In particular, the diametrical magnetic arrangement of the zig-zag type external magnetic field of the device (1) maximizes the magnetic field intensity for actuation outside the diameter of the magnetic SUB, with a configuration of magnet arrangements different from those existing in the State of the Art.

Thus, during the development of the present device (1), several computational simulations were carried out to design the magnet arrangements with greater efficiency, that is, with greater intensity and greater uniformity of the magnetic field lines.

Additionally, criteria based on the theoretical approach of the magnetohydrodynamic (MHD) model were developed to explain the phenomenon of interaction between magnetic field and fluid, and thus design new efficient magnetic arrangements.

In order to fulfill the objective of maximizing the magnetic field intensity for action external to the diameter of the magnetic SUB, the device (1) of the present Utility Model comprises at least one magnetic arrangement (10), including at least 8 magnets (11); and at least one inner tube (20) to the magnetic arrangement, wherein the inner tube (20) can also be called support or core, and wherein the inner tube (20) is permeable and made of ferromagnetic material.

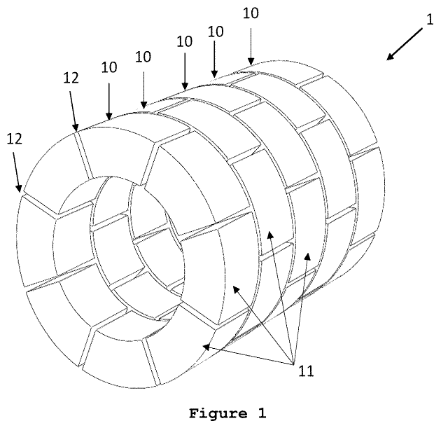

As can be seen in FIG. 1, said at least one magnetic arrangement (10) includes at least 8 magnets (11), wherein the at least 8 magnets (11) have a trapezoidal shape with cylindrical internal and external sections. Additionally, between the at least 8 magnets (11) there is a separation (12), wherein the separation distance (12) is about 4 millimeters.

Furthermore, at least one magnetic arrangement (10) including the at least 8 magnets (11) arranged, form a cylinder with an outer diameter of about 18.8 centimeters and an inner diameter of about 11.4 centimeters.

In particular, each of the at least eight magnets (11) has a length of about 5 cm. Specifically, for the 5 cm length of the magnets (11), it is recommended to maintain an average fluid flow velocity of around 3 m/s.

More particularly, between the magnets (11) there is separation (12), wherein the separation distance (12) between the magnets (11) is approximately 4 millimeters, and this separation distance (12) must be filled with Inconel plate or other material with similar mechanical and magnetic characteristics: that is, any material resistant to the well conditions and which does not shield the action of the magnetic field. In particular, the Inconel plates serve as support to prevent magnets crushing (11), due to the pressure differential in the well, and to prevent demagnetization between magnets (11) of different orientations.

Also, it is important to point out that the device (1) of the present Model preferably uses higher grade neodymium (NdFeB) magnets (11) such as N48SH (or higher grade) which offers high work efficiency at high temperatures, or another grade or magnet material (11) with similar physics and mechanics properties. These magnets (11) offer great magnetic energy at high working temperatures (greater than 100 100° C.), especially for application in the extreme conditions of pre-salt wells.

Among the at least 8 magnets (11) that make up the magnetic arrangement (10), at least 4 magnets (11) have a convergent magnetic field direction in relation to the center of the cylinder formed by the magnetic arrangement (10), and the other at least 4 magnets (11) have a divergent magnetic field direction in relation to the center of the cylinder formed by the magnetic arrangement (10). In other words, in this magnetic arrangement configuration (10), 2 types of magnets (11) are required, which provides savings in the manufacture of this type of magnetic arrangement (10) of the present Utility Model.

Complementarily, each magnetic arrangement (10) is rotated around 22.5° with respect to a previous magnetic arrangement (10) and a subsequent magnetic arrangement (10), so that the fluid, flowing along Z at each XY point, interacts in a zig-zag pattern with the magnetic field along the flow (Z), thus solving the problem of fluctuations in the intensity of the magnetic field along the fluid flow. This zig-zag characteristic of the magnetic arrangement (10) is showed in FIG. 1.

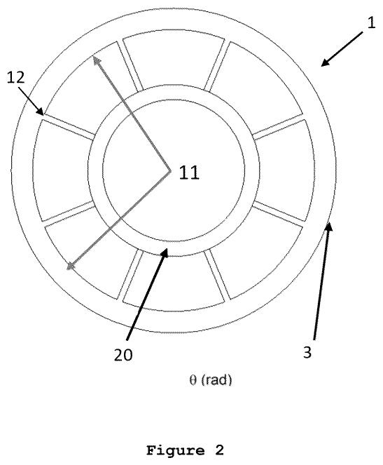

As observed in FIG. 2, at least one inner tube (20) to the magnetic arrangement (10) is impermeable to the magnetic field, which allows shielding the magnetic field in the internal region of the device (1) of this Utility Model and directing the magnetic field to the external area, where it will perform the function of treating the fluid that passes through the annular region formed between the open well and the pipe (production column). In particular, the inner tube (20) may be approximately 8 millimeters thick, but this dimension will depend on the project in which the device of the Utility Model will be applied.

To achieve the effect of directing the magnetic field to the external area, the inner tube (20) with at least one magnetic arrangement (10) must have a characteristic of permeating and concentrating the magnetic field produced by the magnets (11) in the area external to the device (1), and to do so, the inner tube (20) must be made of a ferromagnetic material in its internal part, such as SuperDuplex (SD) steel. The external tube (3) to the magnets is made of austenitic material, such as Inconel or some other material impermeable to the magnetic field, wherein these materials are usually used in production columns.

Thus, the device (1) for generating an external magnetic field in production columns of this Utility Model presents, through the results of tests performed, an oscillating external magnetic field intensity between 0.5 and 0.83 T at radius r=9.8 cm (close to the external surface of the magnetic SUB) and between 0.31 and 0.44 T at radius r=10.8 cm (close to the well wall), when an Inconel inner tube (20) is used. In this test, the radius r of the peripheral magnets is 9.35 cm.

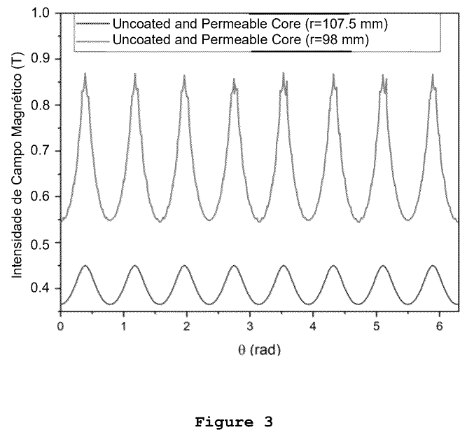

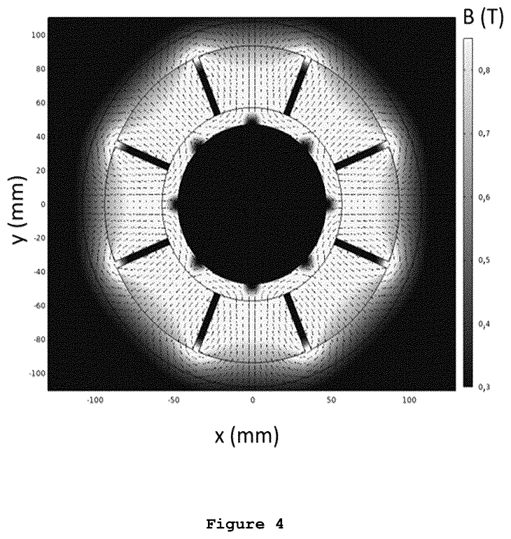

On the other hand, through other tests carried out, when using a permeable SuperDuplex (SD) steel inner tube (20), the magnetic field intensity in the annulus where the fluids will flow varied between 0.55 and 0.85 T at radius r=9.8 cm (close to the external surface of the SUB), and between 0.35 and 0.45 T at radius r=10.8 cm (close to the well wall). Therefore, when using SuperDuplex (SD) steel, there was an increase in the intensity of the external magnetic field, as can be seen in FIGS. 3 and 4.

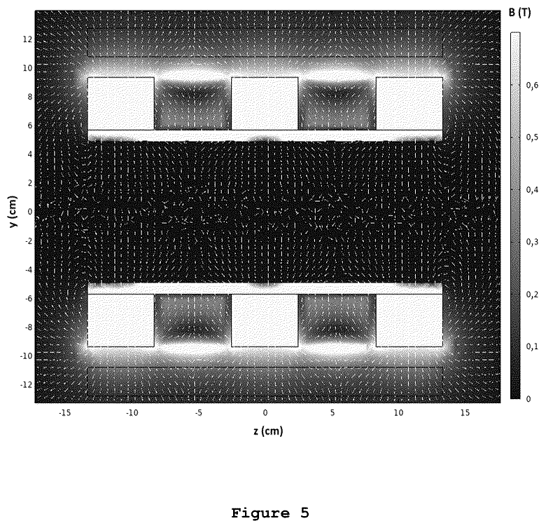

In FIG. 5, the intensity of the magnetic field can be observed along the annulus, where fluids flow without coating and with a permeable SuperDuplex (SD) steel core.

Therefore, the tests carried out on the device (1) of this Utility Model identified an effective inhibition of CaCO₃ scaling (and other carbonates) on the magnetic SUB of up to 52% (result obtained by the mass of CaCO₃ deposited on the walls). This occurred due to the field variation between 0.55 and 0.85 T and the development of new physical models of the application of magnetohydrodynamics (MHD) in static magnetic fields and ionic fluid flows. By associating this relationship with the magnetic field intensities and keeping the other flow parameters identical, a scale inhibition efficiency of up to 52% is expected on the magnetic SUB.

Thus, the actuation of the device (1) of the present Utility Model with a permeable inner tube (20) has a greater magnetic field intensity than the actuation without the use of an inner tube (20) in the annular fluid flow region. The device (1) of this Utility Model presented a more uniform magnetic field intensity (low intensity drop), mitigating scalings on the periphery of the magnetic SUBs or in annular sections peripheral to the magnetic SUB, helping to mitigate scaling in the wells in peripheral regions or external to the magnetic SUBs, or external to the production tails, protecting valves and other devices on their periphery.

Those skilled in the art will value the knowledge presented herein and will be able to reproduce the Utility Model in the presented embodiments and in other variants, covered in the scope of the appended claims.

1. A device for generating an external magnetic field in production columns, wherein the device comprises:
at least one magnetic arrangement comprising at least eight magnets arranged to form a cylinder;
wherein the at least eight magnets have a trapezoidal shape and a cylindrical internal and external section;
wherein at least four magnets of the at least eight magnets have a convergent magnetic field direction with respect to a center of the cylinder formed by the magnetic arrangement; and at least four magnets of the at least eight magnets have a divergent magnetic field direction with respect to the center of the cylinder formed by the magnetic arrangement;
wherein each magnetic arrangement is rotated by 22.5° with respect to a previous magnetic arrangement and a subsequent magnetic arrangement;
wherein the device further comprises:
at least one inner tube arranged inside the at least one magnetic arrangement.

2. The device of claim 1, wherein the at least eight magnets are of higher grade neodymium (NdFeB) such as N48SH.

3. The device of claim 1, wherein between the at least eight magnets there is a separation, wherein the separation distance is 4 millimeters from each other, and wherein in the separation an Inconel plate is arranged; and wherein each magnet has a length of 5 centimeters.

4. The device of claim 1, wherein the at least one magnetic arrangement has an outer diameter of 18.8 centimeters and an inner diameter of 11.4 centimeters.

5. The device of claim 1, wherein at least one outer tube is made of Inconel or any austenitic material.

6. The device of claim 1, wherein at least one inner tube is made of SuperDuplex (SD) steel or any permeable material.

7. The device of claim 1, wherein the at least one inner tube is 8 millimeters thick.
